(19) United States
(12) Patent Application Publication
(10) Pub. No.: US 2018/0370198 A1
(43) Pub. Date: Dec. 27, 2018

(54) Multi-Layer Liner for Waste Water System Rehabilitation

(71) Applicant: SpectraShield Holdings, LLC, Jacksonville, FL (US)

(72) Inventor: James M. Hume, Jacksonville, FL (US)

(21) Appl. No.: 15/263,723

(22) Filed: Sep. 13, 2016

(51) Int. Cl. B32B 27/06; B32B 5/18; B32B 27/40

(52) U.S. Cl. CPC B32B 27/065; B32B 5/18; B32B 27/40; B32B 2307/536; B32B 2581/00; B32B 2307/7265; B32B 2307/54; B32B 2250/40; B32B 2266/0278; B32B 2307/72

(57) ABSTRACT

A method and apparatus for rehabilitating or repairing waste water system components or the like comprising a spray-applied, multi-layer liner which seals the components and imparts structural integrity. The liner comprises a first moisture barrier layer, a foam layer and a second moisture barrier layer. A primer may be applied where desired. Typically, the first and second moisture barrier layers are made of the same material for forming a skin on both sides of the foam layer. The combination of the foam layer and the two moisture barrier layers imparts structural strength and rigidity to the cured liner.

This application is a continuation in part of application Ser. No. 15/088,650, filed on Apr. 1, 2016 and claims priority therefrom. Said application is fully incorporated by reference.

### BACKGROUND OF THE INVENTION

The invention relates generally to the rehabilitation or repair of waste water system components, such as manholes, sewer pipes, lift stations or clarifiers, through the application of a multi-layer liner. More particularly, the invention relates to the rehabilitation of such systems where the multi-layer liner is spray-applied and comprises a first moisture barrier layer, a foam intermediate layer and a second moisture barrier layer. As an option, a primer layer may be applied prior to application of the first moisture barrier.

Deterioration of waste water system components is a severe and growing problem. Originally built of brick, block or concrete construction, these components develop leaks, cracks and holes due to age, erosion, corrosion and ground water intrusion. Leakage from old manholes and sewer lines contaminates the environment and sometimes result in catastrophic damage with respect to clean-up and repair costs.

Since the cost of repairing the components is typically much less than the cost of replacement, many techniques have been developed to repair and rehabilitate waste water system components.

For example, it is known to recast manholes and the like through the use of forms and poured concrete, such as shown in U.S. Pat. No. 5,032,197 to Trimble. Because this process is very labor intensive, many techniques are directed toward spray-applied liners. For example, Strong in U.S. Pat. No. 5,002,438 teaches the use of sprayed cement to form a liner inside the deteriorating structure. Spray-applied epoxy, acrylic or polyurethane liners are also known, as is the use of resin impregnated substrates, such as felt, as taught in U.S. Pat. No. 5,017,258 to Brown et al. The current spray-applied systems suffer from moisture, delamination, shrinkage and structural weakness problems resulting from the typical environment encountered in the repair operation. My earlier U.S. Pat. Nos. 5,618,616 and 7,279,196 also provide systems and methods designed for the repair and rehabilitation of waste water system components.

It is an object of this invention to provide a technique and particular liner structure for repairing waste water system components which is spray-applied and does not suffer from the problems relation to moisture, delamination shrinkage and structural weakness.

It is a further object to provide such an invention which increases the structural integrity of the repaired component due to the unique composition of the layers within the multi-layer laminate applied to the component.

It is still another object to provide such an invention which can be applied in damp conditions to any shape surface having any n umber of irregularities and has a rapid cure time.

### SUMMARY OF THE INVENTION

The invention is a technique and device for rehabilitating or repairing waste water system components or the like, comprising a spray-applied, multi-layer liner which seals the components and imparts structural integrity. The liner comprises at least first moisture barrier layer, a foam layer and a second moisture barrier layer.

A primer layer can be applied to damp surfaces to provide an additional bonding layer between the waste water system component, typically a concrete or cement surface, and the first moisture barrier layer. The first and second moisture barrier layers are preferably made of the same material and form a skin on both sides of the internal foam layer. The combination of the foam layer and the two moisture barrier layers imparts structural strength and rigidity to the cured liner. Except for the primer layer when used, the layers of the liner are all rapid curing materials. Preferably, the primer layer is an epoxy. The moisture barrier layers each have a minimum shore D hardness of fifty (50), and the middle, intermediate layer consists of a polymer foam having a density of at least 3.2 pounds.

### BRIEF DESCRIPTION OF THE DRAWINGS

FIG. 1 is cross-sectional perspective view of a portion of a four-layer multi-layer liner as applied to a concrete substrate using a primer.

FIG. 2 is cross-sectional perspective view of a portion of a three-layer multi-layer liner as applied to a concrete substrate wherein the first barrier layer is applied directly to a concrete substrate.

### DETAILED DESCRIPTION

A multi-layer liner is spray-applied using conventional compressed air and/or airless techniques to rehabilitate and repair deteriorated waste water systems or the like, permitting and supporting both a one pump and a two pump system. The liner components have rapid cure rates and the cured liner imparts structural strength and integrity to the rehabilitated components.

Waste water system components, such as manholes, sewer pipes, lift or pump stations, and clarifiers, degrade and deteriorate over time—resulting in loss of integrity and Leakage of liquid components in to the environment. Likewise, many other similar concrete or metal structures deteriorate and need to be repaired in a rapid, effective manner.

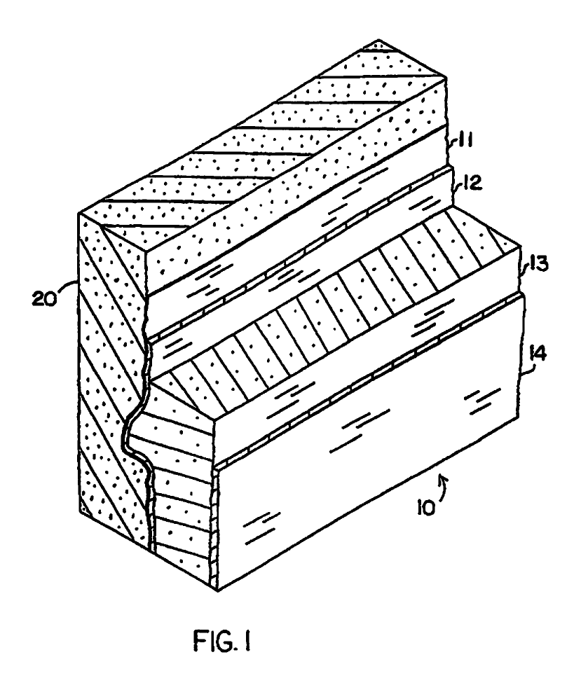

As illustrated by the sectional depiction in FIG. 1, the invention comprises a multi-layer liner 10 applied to a concrete, brick, block, metal or the like substrate 20. Typically, the substrate 20 will be a deteriorated manhole or sewer pipe having an irregular surface with cracks or holes. In this embodiment the liner 10 comprises a primer layer 11, a first moisture barrier layer 12, an intermediate foam layer 13, and a second moisture barrier layer 14. The liner IO is applied so as to cover the entire internal surface of the substrate 20, which is usually generally tubular in configuration, although any shape or configuration is possible and the technique is applicable without regard to the particular shape of the substrate 20.

The primer is typically an epoxy. The first barrier layer 12 and the second barrier layer 14 each have a preferred minimum shore D hardness of thirty (30) with a shore D hardness of fifty (50) in the acceptable range. The intermediate layer consists of a polymer foam having a density of approximately 1.3 pounds. The polymer foam may have density in the range of 1.2 pounds to 3.0 pounds or higher. The polymer may be a plastic, and is included but is not limited to an epoxy, a polyurea, a urethane, or any material that cross links to cure.

The substrate 20 surface is initially prepared using high pressure water or abrasive sand blasting to remove all hard contaminants, any micro-organisms or living matter such as mold, mildew, etc., and any loose degraded materials of the substrate itself. This abrading step results in a clean surface with an optimized surface for adhesion of the liner 20. Next the primer layer 11 is spray-applied using conventional compressed air spraying devices. Airless systems may also be used.

The primer layer 11 is optional and constitutes any material, including water, which will enhance the capability of the first moisture barrier layer 12 adhering to the substrate. Preferably, when used, the primer layer is a material capable of increasing the bond to the substrate 20 even if damp, and is preferably an epoxy material. In specific applications the primer can be used to fill or reduce the size of anomalies in the substrate. The condition of the substrate determines the type of or even need for a primer. The primer layer 11 is applied to a necessary thickness to insure adhesion of the first moisture barrier 12 to the substrate 20, and is generally applied to a dry film thickness between 2 and 10 mils, and preferably at a thickness of approximately 5 mils. When used, the primer layer 11 is coated over the entire surface to be repaired.

The next step is to spray-apply, again using conventional techniques, the first moisture barrier layer 12 onto the primer layer 1 1. The first moisture barrier layer 12 is composed of a polymer blend of separate components which are mixed as they exit the spray nozzle, the components reacting to form a hard upon curing. [0019] Preferably, a blend of a polyurea component and an isocyanate component is utilized, with the two components formulated to have similar viscosities.

The first moisture barrier layer 12 is applied to a dry film thickness of preferably between 20 to 80 mils, and even more preferably at a thickness of 60 mils. The material used for the first moisture barrier should have a gel time of less than a few seconds and preferably less than 3 seconds, typically 15 seconds to tack free, and have minimal shrinkage during curing. This rapid cure is necessary to insure integrity of the first moisture barrier 12 even when applied under non-optimum conditions. The preferred polyurea and isocyanate blend has a tensile strength of greater than 750 psi, an elongation percentage of a minimum 125%, tear strength of 350 psi, a shore D minimum hardness of 10, and preferably greater than 30, and a 100% modulus of greater than 1500. The first moisture barrier layer 12 is impermeable to water and other fluids and is a structurally rigid layer adhered to the substrate 20 so as to remain adhered under pull test conditions of greater than 150 psi, or substrate failure. The first moisture barrier layer 12 is applied to completely cover the primer layer 11.

The next step is to spray-apply, again using conventional techniques, an internal foam layer 13. The foam layer 13 is preferably composed of a polyurethane blend which rapidly foams and cures upon exiting the spray nozzle of the application equipment. Preferably, the foam material is primarily closed cell and has a rise time of less than 30 seconds and preferably less than 10 seconds. The foam layer 13 is applied preferably to result in a dry thickness of at least 500 mils, although the foam layer 13 can be thicker overall or in selected areas if necessary. The foam layer 13 as applied creates a smoother inner surface, its bulk filling any holes, depressions, or cracks in the substrate 20 surface. The foam layer 13 preferably has a density of at least 1.2 and preferably as high as 30.0 pounds per cubic foot, a compressive strength of generally between 30 and 110 psi, a closed cell content of over 90 percent, and shear strength of between 225 to 250 psi. As with the other layers, the foam layer 13 is applied over the entire previous layer.

Finally, the second moisture barrier layer 14, preferably composed of the same material as the first moisture barrier layer 12, is spray-applied over the entire surface of foam layer 13. Preferably, the second moisture barrier layer 14 is also applied to a dry film thickness of between 40 and 80 mils, and even more preferably to a thickness of approximately 60 mils. If necessary due to circumstances, greater thicknesses of first moisture barrier layer 12 and second moisture barrier layer 14 may be utilized.

The resulting liner 10 is a water impermeable barrier strongly adhered to the substrate 20 which prevents liquids from leaking out of the waste water system and also prevents ground water from entering the system. More importantly in terms of longevity, the liner 10 is a structural member which strengthens the components of the waste water system no matter to what extent they have deteriorated. Previously used water impermeable liners, whether composed of epoxy, acrylic, polyurethane or resin impregnated substrates, are not strongly adhered to the substrate and tend to delaminate over time. These typical liners do not reinforce or impart any structural strength to the system components. The multi-layer liner 10 of the invention not only creates a liquid barrier, it adds to the strength of the waste water system components by providing a reinforcing member which is structurally rigid due to its multi-layer composition. The liner 10 is a stressed skin panel, comprised of a structurally rigid foam internal layer 13 bounded by two adhered surface layers—first moisture barrier layer 12 and second moisture barrier layer 14—which are under stress due to the rapid cure rate of the material when applied.

This rapid cure time does not allow internal stresses created by the small amount of shrinkage during curing to be relaxed, as occurs in sprayed films with long cure times. The principles of stressed skin panels, well known in the construction industry for walls of large buildings, provide for a structural member with increased structural strength and integrity of multiple factors beyond that of the individual components taken separately. Thus, the combination of the stressed skin panel created by the multi-layer combination of first moisture barrier layer 12, foam internal layer 13 and second moisture barrier layer 14 adhered to the waste water system component results in a repaired component with exceptional structural characteristics due to the reinforcing properties of the liner 10, and is a vastly improved system over those in use today.

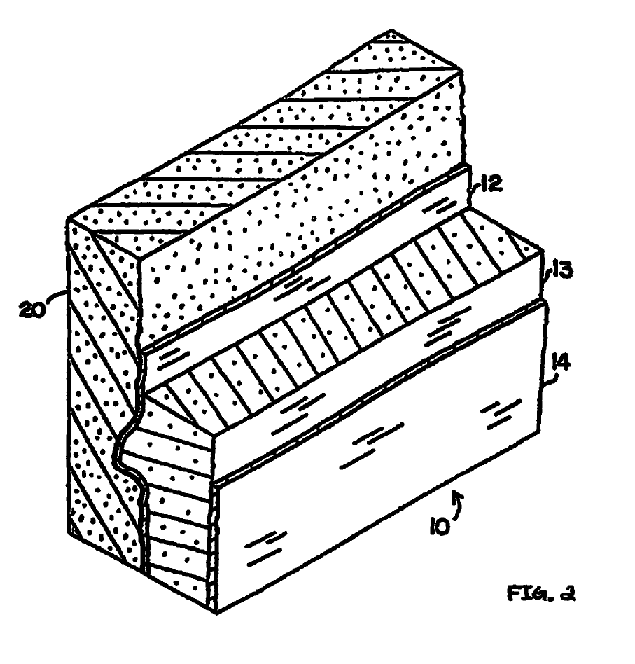

In a, three-layer embodiment of the invention, as shown in FIG. 2, the liner JO is composed of a first barrier layer 12, an intermediate layer 13 and a second barrier layer 14. The primer is not used. The barrier layers have the same properties as described for the barrier layer of the first embodiment. Likewise, the intermediate layer 13 of the second embodiment is identical to the intermediate layer of the first embodiment.

The substrate surface 20 is prepared as previously described and the first barrier layer 12 is spray-applied thereto. The foam layer 13 is then applied so as to completely cover the first barrier layer 12. The second barrier layer 14 is then applied to cover the foam layer 13.

The resulting liner 10 from either embodiment is a water impermeable barrier strongly adhered to the substrate which prevents liquids from leaking out of the waste water system or concrete structure and also prevents ground water from entering the system. More importantly in terms of longevity, the liner I O is a structural member which strengthens the components of the water system no matter to what extent they have deteriorated or to what extent they are exposed to corrosive substances or materials. Previously used water impermeably liners, whether composed of epoxy, acrylic, polyurethane or resin impregnated substrates, are not strongly adhered to the substrate and tend to delaminate over time. These typical liners do not reinforce or impart any structural strength to the system components. The liners of the present invention not only create a liquid barrier; they add to the strength of the waste water system components by providing a reinforcing member which structurally rigid due to its layered composition.

The liner of the second embodiment is a stressed skin panel, comprised of a structurally rigid foam internal layer bounded by two adhered surface layers—first moisture barrier layer and second moisture barrier layer—which are under stress due to the rapid cure rate of the material when applied. This rapid cure time does not allow internal stresses created by the small amount of shrinkage during curing to be relaxed, as occurs in sprayed films with long cure times. The principles of stressed skin panels, well known in the construction industry for walls of large buildings, provide for a structural member with increased structural strength and integrity of multiple factors beyond that of the individual components taken separately. Thus, the combination of the stressed skin panel created by the multi-layer combination of first moisture barrier layer, foam internal layer and second moisture barrier layer adhered to the waste water system component results in a repaired component with exceptional structural characteristics due to the reinforcing properties of the liner, and is a vastly improved system over those in use today.

It is understood that obvious equivalents and substitutions may become known to those skilled in the art. The true scope and definition of the invention therefore is to be as set forth in the following claims.

What is claimed is:

1. A multi-layered liner for a substrate, comprising:
a first moisture barrier layer and second moisture barrier layer each having a minimum shore D hardness of approximately thirty (30), and
a middle, intermediate layer consisting of a polymer foam having a density of approximately 1.2 pounds or more,
wherein said first moisture barrier layer being impervious to moisture, and
wherein said foam layer is sandwiched between said first barrier layer and said second barrier layer.

2. The liner of claim 1, wherein the polymer foam has a density in the range of 1.2 pounds to 3.0 pounds.

3. The liner of claim 1, wherein the polymer is any one of the following: polyester, plastic, epoxy, polyurea, polyurethane, urethane.

4. The liner of claim 1, wherein the polymer is a polyurethane.

5. The liner of claim 1, wherein the polymer is a polyester.

6. The liner of claim 1, wherein the polymer is a plastic.

7. The liner of claim 1, wherein the polymer is an epoxy.

8. The liner of claim 1, wherein the polymer is a polyurea.

9. The liner of claim 1, wherein the polymer is a urethane.

10. The liner of claim 1, wherein the polymer is a material that cross links to cure.

11. The liner of claim 1, further including a primer applied directly to the substrate, with the first moisture barrier being applied to the primer.

12. The liner of claim 1, wherein said first moisture barrier layer, said foam layer and said second moisture barrier layer have cure rates of less than sixty (60) seconds.

13. The liner of claim 12, wherein cure rates are a minimum of eight (8) seconds.

14. The liner of claim 1, wherein the foam layer is composed of or at least includes a silicate component.

15. The liner of claim 1, wherein the first moisture barrier is applied directly to the substrate.

16. The liner of claim 1, wherein said intermediate layer is a polymer

17. The liner of claim 1, wherein said first moisture barrier layer and said second moisture barrier layer are composed of the same material.

18. The liner of claim 1, wherein said same material is a polymer.

19. The liner of claim 1, wherein said first moisture barrier layer and said second moisture barrier layer are composed of a polyurea.

20. The liner of claim 11, wherein said first moisture barrier layer and said second moisture barrier are composed of a polyurea and isocyanate blend.

21. The liner of claim 1, wherein said foam layer is composed of a polyurethane.

22. The liner of claim 1, wherein said primer layer is composed of an epoxy.

23. The liner of claim 1, wherein said first moisture barrier layer and said second moisture barrier layer are less than 80 mils in thickness.

24. The liner of claim 1, wherein said foam layer is greater than 500 mils in thickness.

25. The liner of claim 18, wherein said foam layer is greater than 500 mils in thickness.

26. The liner of claim 1, where said first moisture barrier layer, said foam layer and said second moisture barrier layer have a gel cure rate of approximately 12 seconds permitting application of another layer and a full cure rates of less than 60 seconds.

27. The liner of claim 20, where said cure rates are less than 60 seconds.

28. A method for lining concrete structures comprising:
a. preparing a surface of a concrete structure for receipt of a foam material by applying a first barrier layer having a minimum shore D hard ness of thirty (30);
b. applying a foam material foam having a density of at least 1.2 pounds directly to said barrier layer; and
c. applying a second barrier layer having a minimum shore D hardness of thirty (30) directly to the foam.

29. The method of claim 28, further including the step of applying a primer directly to the concrete structure before applying the first barrier layer.

30. The method of claim 28, wherein one of said layers provides rigidity and structural integrity to the liner.

31. The liner of claim 28, wherein said cure rates are a minimum of eight (8) seconds.
